(19) United States
(12) Patent Application Publication
(10) Pub. No.: US 2022/0398351 A1
(43) Pub. Date: Dec. 15, 2022

(54) METHOD AND SYSTEM FOR REVERSE DESIGN OF MICRO-NANO STRUCTURE BASED ON DEEP NEURAL NETWORK

(71) Applicant: Tsinghua University, Beijing (CN)

(72) Inventors: Kaiyu Cui, Beijing (CN); Jian Xiong, Beijing (CN); Yidong Huang, Beijing (CN); Wei Zhang, Beijing (CN); Xue Feng, Beijing (CN); Fang Liu, Beijing (CN)

(73) Assignee: Tsinghua University, Beijing (CN)

(21) Appl. No.: 17/377,147

(22) Filed: Jul. 15, 2021

(30) Foreign Application Priority Data
Jun. 11, 2021 (CN) 2021106558401

(51) Int. Cl. G06F 30/10; G06N 3/067; G06N 3/08

(52) U.S. Cl. CPC G06F 30/10; G06N 3/067; G06N 3/086; G06F 2111/14

(57) ABSTRACT

Methods and systems for reverse design of micro-nano structure based on a deep neural network. The method includes step 101 of acquiring initial data of a micro-nano structure according to the micro-nano structure to be reversely designed. The method also includes step 102 of inputting the initial data of the micro-nano structure into a trained optical parameter prediction model to obtain optical prediction parameters. The method further includes step 103 of evaluating the optical prediction parameters. The method also includes optimizing the initial data of the micro-nano structure, inputting the optimized data of the micro-nano structure into the trained optical parameter prediction model, and performing steps 102 and 103 again until the evaluation result of the optical prediction parameters obtained in a current iteration satisfies the preset condition. Through the method of the present application, the electromagnetic response calculation time of the reverse design is greatly shortened.

### CROSS-REFERENCE TO RELATED APPLICATIONS

The present application claims priority to Chinese Patent Application No. 202110655840.1 filed on Jun. 11, 2021, entitled “Method and System for Reverse Design of Micro-Nano Structure Based on Deep Neural Network,” the disclosure of which is hereby incorporated by reference in its entirety.

### FIELD OF TECHNOLOGY

The present application relates to the technical field of micro-nano optics, in particular to a method and a system for reverse design of micro-nano structure based on deep neural network.

### BACKGROUND

An on-chip micro-nano structure is an important means to control light at the micro-nano scale, and may be configured to manipulate the characteristics of light such as phase, amplitude, propagation mode and resonance.

At present, the design of micro-nano structures is still in a forward design stage, that is, an initial structure is proposed according to a target and physical principles, electromagnetic response data of a device is then obtained through simulation or experiment, parameters of the initial structure are then modified according to the electromagnetic response data, the next simulation or experiment is carried out, and finally the desired device function is achieved gradually. This forward design thinking is often limited by subjective human ideas. For example, not only standard structures (circles, ellipses, rectangles, regular polygons, etc.), but also simplified physical models (such as simplifying 3D problems to 2D problems) are mostly used. This artificial tendency causes the design of structures to be conducted within a restricted parameter space and the final design results may not be optimal, or even fail in some cases. In addition, the forward design process is time-consuming and wastes a lot of computational and experimental equipment resources, which seriously restricts the development of on-chip photonic micro-nano structures.

Therefore, there is an urgent need for a method and a system for reverse design of micro-nano structure based on a deep neural network to solve the above problems.

### SUMMARY

In order to at least solve the problems in the related art, the present application provides a method and a system for reverse design of a micro-nano structure based on a deep neural network.

The present application provides a method for reverse design of a micro-nano structure based on a deep neural network. The method including step 101 of acquiring initial data of the micro-nano structure according to the micro-nano structure to be reversely designed. The method also includes step 102 of inputting the initial data of the micro-nano structure into a trained optical parameter prediction model to obtain optical prediction parameters. The trained optical parameter prediction model is obtained by training a deep neural network based on sample micro-nano data marked with optical attribute parameters. The sample micro-nano data includes sample micro-nano structure data and sample micro-nano optical characteristic data. The method further includes step 103 of evaluating the optical prediction parameters based on an evaluation function and an optical target parameter. When an evaluation result does not satisfy a preset condition, the method also includes optimizing the initial data of the micro-nano structure through an optimization algorithm and the evaluation result to obtain optimized data of the micro-nano structure. The method further includes inputting the optimized data of the micro-nano structure into the trained optical parameter prediction model. The method also includes performing step 102 and step 103 again until the evaluation result of the optical prediction parameters obtained in a current iteration satisfies the preset condition. The method further includes performing the reverse design of micro-nano structure according to the optimized data of the micro-nano structure corresponding to the optical prediction parameters in the current iteration.

According to an embodiment, the trained optical parameter prediction model is obtained by marking each sample micro-nano data with a corresponding label according to the optical attribute parameter, and constructing a training sample set according to labeled sample micro-nano data and a corresponding sample optical parameter. The trained optical parameter prediction model is further obtained by inputting the training sample set into the deep neural network for training, and obtaining the trained optical parameter prediction model.

According to an embodiment, the optimization algorithm includes a simulated annealing algorithm, a neural network algorithm and a genetic algorithm.

According to an embodiment, an input layer of the deep neural network is connected with a plurality of convolutional layers.

According to an embodiment, the method further includes step 201 of obtaining a plurality of initial data of different micro-nano structures, and inputting the initial data of each micro-nano structure into the trained optical parameter prediction model to obtain a plurality of optical prediction parameters, and obtaining an optical prediction measurement matrix according to the plurality of optical prediction parameters. The method also includes step 202 of evaluating the optical prediction measurement matrix based on an evaluation function and optical target parameters. The method further includes, when an evaluation result of the measurement matrix does not satisfy a preset condition, optimizing the initial data of each micro-nano structure through an optimization algorithm and the evaluation result of the measurement matrix to obtain optimized data of the micro-nano structure. The method also includes inputting each optimized data of the micro-nano structure into the trained optical parameter prediction model. The method further includes performing step 201 and step 202 again until the evaluation result of the optical prediction measurement matrix obtained in a current iteration satisfies the preset condition, then performing the reverse design of micro-nano structure according to a plurality of optimized data of the micro-nano structure corresponding to the optical prediction measurement matrix in the current iteration, and constructing a compressed sensor according to the plurality of micro-nano structures obtained from the reverse design.

According to an embodiment, the sample micro-nano structure data includes at least single-period micro-nano structure shape data and micro-nano structure period data.

According to an embodiment, the sample micro-nano optical characteristic data includes at least a dielectric constant and a dispersion parameter of a micro-nano material.

The present application further provides a system for reverse design of micro-nano structure based on a deep neural network. The system includes a micro-nano structure initial parameter acquirer configured to perform step 101, that is: acquiring initial data of a micro-nano structure according to the micro-nano structure to be reversely designed. The system also includes an optical parameter predictor configured to perform step 102, that is: inputting the initial data of the micro-nano structure into a trained optical parameter prediction model to obtain optical prediction parameters. The trained optical parameter prediction model is obtained by training a deep neural network based on sample micro-nano data marked with optical attribute parameters. The sample micro-nano data includes sample micro-nano structure data and sample micro-nano optical characteristic data. The system further includes an evaluation and optimization module configured to perform step 103, that is: evaluating the optical prediction parameters based on an evaluation function and an optical target parameter. Step 103 also includes, when an evaluation result does not satisfy a preset condition, optimizing the initial data of the micro-nano structure through an optimization algorithm and the evaluation result to obtain optimized data of the micro-nano structure. Step 103 further includes inputting the optimized data of the micro-nano structure into the trained optical parameter prediction model. The evaluation and optimization module is further configured to perform step 102 and step 103 again until the evaluation result of the optical prediction parameters obtained in a current iteration satisfies the preset condition, and then perform the reverse design of micro-nano structure according to the optimized data of the micro-nano structure corresponding to the optical prediction parameters in the current iteration.

The present application further provides an electronic apparatus, including a memory, a processor, and computer programs stored on the memory and executable by the processor, wherein the steps of any one of the above-mentioned method for reverse design of micro-nano structure based on the deep neural network are implemented when the processor performs the computer programs.

The present application further provides a non-transitory computer-readable storage medium, with computer programs stored thereon, wherein the steps of any one of the above-mentioned method for reverse design of micro-nano structure based on the deep neural network are implemented when the computer programs are performed by the processor.

In the method and system for reverse design of micro-nano structure based on the deep neural network provided by the present application, the deep neural network is used to predict the electromagnetic response corresponding to the structural parameters. That is, the neural network is trained to predict the electromagnetic characteristics of the micro-nano structure, and the optimal structural parameters that satisfy the target are obtained through iterative optimization according to preset optical target parameters. Since the calculation principle is based on prediction, the calculation time of the electromagnetic response is significantly shortened (10⁵ times faster) compared to the direct calculation of the electromagnetic response using simulation software, allowing for iterative optimization using optimization algorithms. Compared with the forward design, not only the parameters that tend to be globally optimal may be obtained, the design time is also greatly shortened, and significant human resources are saved.

### BRIEF DESCRIPTION OF THE DRAWINGS

In order to more clearly illustrate technical solutions disclosed in certain embodiments of the present application, the drawings aiding in the descriptions of the embodiments are briefly described below. Obviously, the drawings in the following description only show certain embodiments of the present application, and other drawings can be obtained according to the drawings without any creative work for those skilled in the art.

FIG. 1 is a schematic flow chart of a method for reverse design of micro-nano structure based on deep neural network according to an exemplary embodiment of the present application;

FIG. 2 is a diagram of prediction based on a single connected random micro-nano structure according to an exemplary embodiment of the present application;

FIG. 3 is a schematic diagram of prediction based on a multiple connected random micro-nano structure according to an exemplary embodiment of the present application;

FIG. 4 is a schematic design diagram of a regular polygonal micro-nano structure according to an exemplary embodiment of the present application;

FIG. 5 is a schematic design diagram of a regular polygonal micro-nano structure with a height value according to an exemplary embodiment of the present application;

FIG. 6 is a schematic design diagram of a randomly graphic micro-nano structure according to an embodiment exemplary of the present application;

FIG. 7 is a schematic design diagram of a randomly graphic micro-nano structure with height values according to an exemplary embodiment of the present application;

FIG. 8 is a schematic design diagram of a randomly graphic micro-nano structure having symmetry according to an exemplary embodiment of the present application;

FIG. 9 is a schematic design diagram of a micro-nano structure having multiple random graphs according to an exemplary embodiment of the present application;

FIG. 10 is a schematic design diagram of a randomly graphic micro-nano structure with a height value according to an exemplary embodiment of the present application;

FIG. 11 is a schematic structural diagram of a system for reverse design of micro-nano structure based on deep neural network according to an exemplary embodiment of the present application; and

FIG. 12 is a schematic structural diagram of an electronic apparatus according to an exemplary embodiment of the present application.

### DETAILED DESCRIPTION

In order to illustrate the objectives, technical solutions and advantages of the embodiments of the present application clearly, the technical solutions in certain embodiments of the present application will be described clearly and completely in conjunction with the companying drawings. Obviously, the described embodiments are part of the embodiments of the present application, rather than all of the embodiments. All other embodiments obtained by a person of ordinary skill in the art based on the disclosure of the present application without any creative effort fall within the protection scope of the present application.

In order to illustrate the objectives, technical solutions and advantages of the embodiments of present application more clearly, the technical solutions in the embodiments of the present application will be described clearly and completely in conjunction with the accompanying drawings in the embodiments of the present application. Obviously, the described embodiments are part of the embodiments of the present application, rather than all of the embodiments. All other embodiments obtained by a person of ordinary skill in the art based on the embodiments of the present application without any creative effort fall within the protection scope of the present application.

The overall design idea of the reverse design is to first set a target performance of a device, then use various optimization algorithms according to the set performance requirements to finally calculate and design the specific structure of the device waveguide. In the present application, by using the planar micro-nano manufacturing process, various randomly shaped micro-nano structures may be prepared on the surface, and the parameters of the randomly shaped micro-nano structures are automatically optimized by artificial neural networks combined with optimization algorithms such as genetic algorithms and particle swarm algorithms to finally achieve the design requirements for device performance such as amplitude, phase and pass spectrum and the like. In the present application, using the acceleration function of deep neural network, the time of structural electromagnetic simulation may be shortened by 10⁵ times, and the optimization effect is also greatly improved.

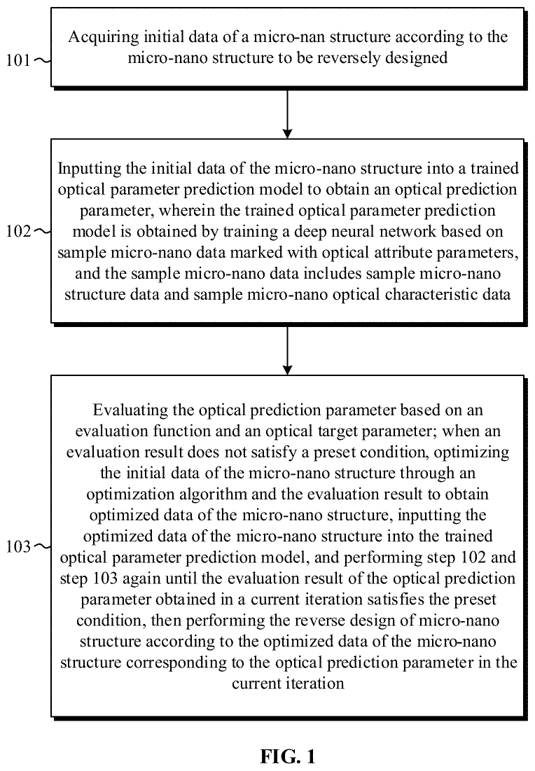

FIG. 1 is a schematic flow diagram of a method for reverse design of micro-nano structure based on a deep neural network according to an embodiment of the present application. As shown in FIG. 1, the present application provides a method for reverse design of micro-nano structure based on a deep neural network, including:

Step 101, acquiring initial data of a micro-nano structure according to the micro-nano structure to be reversely designed.

In the present application, according to the micro-nano structure to be reversely designed, first, a polygonal micro-nano structure having a similar structure to the micro-nano structure is generated, and then according to this polygonal micro-nano structure, a set of initial parameters, i.e. the initial data of the micro-nano structure, is generated. In the present application, the optical parameters may be predicted based on any random polygonal micro-nano structure, so that the previous polygonal micro-nano structure may be optimized according to the optical parameters obtained in each prediction, such that the structure data of the finally obtained polygonal micro-nano structure satisfy the target optical parameters.

Step 102, inputting the initial data of the micro-nano structure into a trained optical parameter prediction model to obtain optical prediction parameters, wherein the trained optical parameter prediction model is obtained by training a deep neural network based on sample micro-nano data marked with an optical attribute parameter, and the sample micro-nano data includes sample micro-nano structure data and sample micro-nano optical characteristic data.

Step 103, evaluating the optical prediction parameters based on an evaluation function and an optical target parameter; when an evaluation result does not satisfy a preset condition, optimizing the initial data of the micro-nano structure through an optimization algorithm and the evaluation result to obtain optimized data of the micro-nano structure, inputting the optimized data of the micro-nano structure into the trained optical parameter prediction model, and performing step 102 and step 103 again until the evaluation result of the optical prediction parameters obtained in a current iteration satisfies the preset condition, then performing the reverse design of micro-nano structure according to the optimized data of the micro-nano structure corresponding to the optical prediction parameters in the current iteration.

In the present application, the optical parameter prediction model is obtained based on training of deep neural network, and the corresponding electromagnetic response of the device, such as transmission spectrum and Q value, is predicted based on the initial parameters of the micro-nano structure. Then, the figure of merit of the electromagnetic response of the device is calculated through the evaluation function and the optical target parameters. In the present application, the evaluation function may be chosen at will as long as satisfying the actual design goals, which include but are not limited to: preset frequency resonance, increasing resonance Q value, shape of preset pass spectrum, preset electric field amplitude and preset phase response. Then, through the optimization algorithm, the initial parameters of the micro-nano structure are optimized according to the obtained evaluation values, thereby generating a set of optimized parameters, and the processes of neural network prediction, prediction result evaluation, and parameter optimization update are continued. Finally, the micro-nano structure parameters corresponding to the global optimal value are obtained, so as to achieve the reverse design according to the micro-nano structure parameters.

In the method for reverse design of micro-nano structure based on a deep neural network provided by the present application, the deep neural network is used to predict the electromagnetic response corresponding to the structural parameters, that is, the neural network is trained to predict the electromagnetic characteristics of the micro-nano structure, and the optimal structural parameters that satisfy the target are obtained through iterative optimization according to preset optical target parameters. Since the calculation principle is based on prediction, the calculation time of the electromagnetic response is significantly shortened, e.g., 10⁵ times faster, compared to the direct calculation of the electromagnetic response using simulation software, such that iterative optimization is carried out using optimization algorithms. Compared with the forward design, not only the parameters that tend to be globally optimal can be obtained, the design time is also greatly shortened, and significant human resources are saved.

On the basis of the foregoing embodiment, the trained optical parameter prediction model is obtained by training in the following steps:

marking each sample micro-nano data with a corresponding label according to the optical attribute parameter, and constructing a training sample set according to the labeled sample micro-nano data and a corresponding sample optical parameter; and

inputting the training sample set into the deep neural network for training, and obtaining the trained optical parameter prediction model.

In the present application, the number of hidden layers of the deep neural network is about 3 to 20; the data dimension of an input layer, which varies according to the actual structural complexity, is roughly about 3 to 10,000; output parameters, i.e. optical prediction parameters obtained from the deep neural network prediction may include but are not limited to resonance wavelength, resonance Q value, pass spectrum, amplitude and phase response, and the dimension of the output parameters is roughly about 1 to 1000. In the present application, the training samples and test samples of the deep neural network may be calculated by commercial software such as FDTD, FEM or Rsoft, or may be calculated by programming using the Fourier modal method, also known as strictly coupled mode analysis method.

Further, when constructing a training set, in view of different requirements of the optical parameter prediction, the sample micro-nano data, including the sample micro-nano structure data and the sample micro-nano optical characteristic data, are marked with different optical attribute parameters, and constructed into a sample group with the corresponding sample optical parameter. For example, assuming that the parameter data, including the micro-nano structure data and the micro-nano optical characteristic data, of the micro-nano structure of the current set of samples is used for the prediction of the pass spectrum, i.e., the optical attribute parameters marked with “used for the pass spectrum prediction”, then this group of parameter data of the micro-nano structure and the actually calculated pass spectrum parameters, i.e., the sample optical parameters, constitute a group of samples set; if it is used for other usages, such as prediction of light intensity and resonance Q value, this group of parameter data of the micro-nano structure are combined with the corresponding actual calculated optical parameters to constitute a sample set. Different sample sets are used as training sets to train different prediction networks, which may be used to predict various optical parameters of different micro-nano structures. In the present application, the sample micro-nano data includes sample micro-nano structure data and sample micro-nano optical characteristic data, wherein the sample micro-nano structure data includes at least single-period micro-nano structure shape data, for example, the number of sides and height of the polygon corresponding to the micro-nano structure, the edge point data of the micro-nano structure, and the thickness of the micro-nano plate, and the micro-nano structure period data. For the polygon of standard structure, it may also include the rotation angle of the micro-nano structure; the sample micro-nano optical characteristic data includes at least a dielectric constant and a dispersion parameter of a micro-nano material.

Specifically, FIG. 2 is a schematic diagram of prediction based on a single connected random micro-nano structure according to an embodiment of the present application. As shown in FIG. 2, the deep neural network consists of 3 to 100 fully connected layers and input/output layers. The data of the input layer has about 3 to 100 dimensions, and the data are the coordinates of each point of the random polygon (polygon contour edge points P₁, P₂, P₃, . . . , Pₙ) in turn, if the polygon has a standard structure, such as a circle, an ellipse, or a rectangle, the distance between the edge point and the center point of the standard structure may also be used as the input data. In addition, the input data includes but not limited to the dielectric constant of the micro-nano material, the dispersion of the micro-nano material, the thickness of the plate, the unit period and other parameters, and the data of the output layer have dimensions of about 1 to 1000. By defining a height value in the input data, the random polygon obtained by the reverse design may be a cavity, i.e., the polygon area being etched away, or may be a column, i.e., the area outside the polygon being etched, making it a column. In the present application, the thickness of the designed micro-nano structure is about 50 nm to 3 μm, and the period is about 100 nm to 100 μm. After the micro-nano structure data are iteratively optimized through deep neural networks and optimization algorithms, structural parameters close to the global optimal value are obtained, and the corresponding single connected micro-nano structure may be obtained through reverse design.

On the basis of the foregoing embodiments, the input layer of the deep neural network is connected with a plurality of convolutional layers.

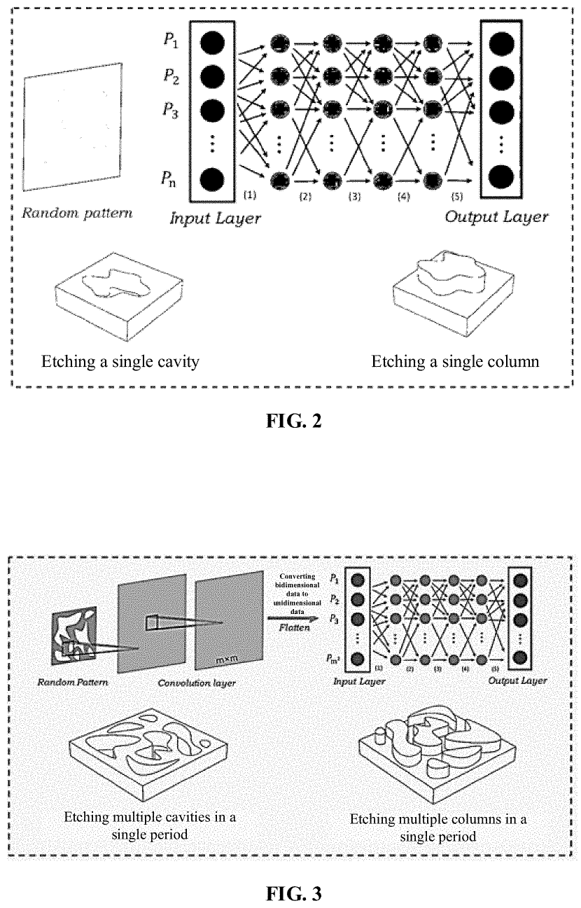

FIG. 3 is a schematic diagram of prediction based on a multiple connected random micro-nano structure according to an embodiment of the present application. As shown in FIG. 3, the input layer of the deep neural network is connected with a multi-layer convolutional layer in front of the input layer, and the input is a graphic structure with random properties. The random structure is a cavity or column with any topological number, and other parameters are similar to those of the single-connected random micro-nano structure. The random structure is randomly generated by a computer, and the image data of the random structure is extracted by the multi-layer convolutional layer, and finally the convolutional layer data of m×m pixels (100 to 10000 dimensions) are obtained. The data is flattened to obtain the array data of m², and then transmitted to the deep neural network for prediction of optical parameters. Moreover, in the present application, in addition to the array data of m², the dielectric constant of the micro-nano material, the dispersion of the material, the thickness of the plate and the unit period are also input into the deep neural network, and structural parameters close to the global optimal value are obtained after micro-nano structure data are iteratively optimized through deep neural networks and optimization algorithms, so that the corresponding multi-connected micro-nano structure is obtained by reverse design. Using deep neural networks, the electromagnetic response of random structures may be accurately predicted, and the results obtained may be used for reverse design optimization.

On the basis of the forgoing embodiments, the optimization algorithm includes simulated annealing algorithm, neural network algorithm and genetic algorithm.

In the present application, three major non-classical algorithms of optimization theory, namely the simulated annealing (SA), neural network (NN) and genetic algorithm (GA) are used, so that the quality of the final optimization result may be greatly improved, and a good result close to the global optimum may be obtained. In addition, different optimization algorithms may be selected according to actual problems to achieve the best results, for example, particle swarm algorithm, downhill algorithm, or Monte Carlo method.

In the present application, the case where there are multiple random polygons in the micro-nano structure will be described with reference to the following embodiments.

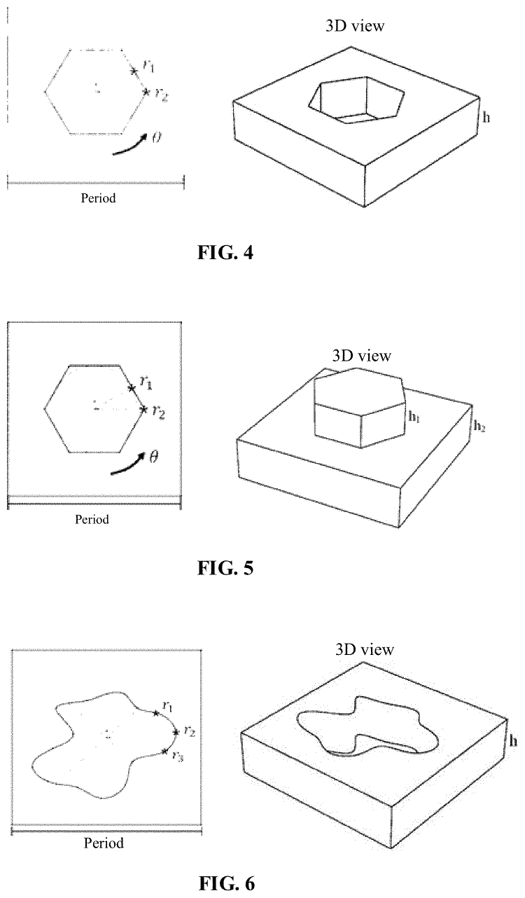

In an exemplary embodiment, optimization of micro-nano structure parameters by prediction of pass spectrum with the shape of the micro-nano structure as a regular polygon is taken as an example for illustration. FIG. 4 is a schematic design diagram of a regular polygonal micro-nano structure according to an embodiment of the present application. As shown in FIG. 4, the parameters of the regular polygonal micro-nano structure are defined as follows: the number of sides of the polygon is N, the period is P, the distance between the edge point and the center point is r₁ and r₂, and the rotation angle is θ. Specifically, firstly, a preset pass spectrum shape is given, and an initial parameter is generated through an optimizer (an optimization algorithm); then the pass spectrum corresponding to the initial parameter is predicted through the deep neural network, and the predicted pass spectrum is evaluated through the evaluation function. In the present application, the evaluation function is set as: figure of merit f=MSE (figure of merit f is equal to predicted pass spectrum minus preset target pass spectrum), and MSE represents the mean square error. The figure of merit f is input into the optimizer (genetic algorithm, simulated annealing or particle swarm algorithm may be used), and then a new parameter is generated, and this new parameter is input into the deep neural network. Through step-by-step iteration, the final parameters may be iteratively optimized to approximate the global optimal value. In addition, polygonal cavities or polygonal columns may be selected as the micro-nano structure. FIG. 5 is a schematic design diagram of a regular polygonal micro-nano structure with a height value according to an embodiment of the present application. As shown in FIG. 5, the micro-nano structure parameters input to the deep neural network further include the height value h in addition to the above parameters (the number of sides of the polygon N, the period P, the distance between the edge point and the center point r₁ and r₂, and the rotation angle θ).

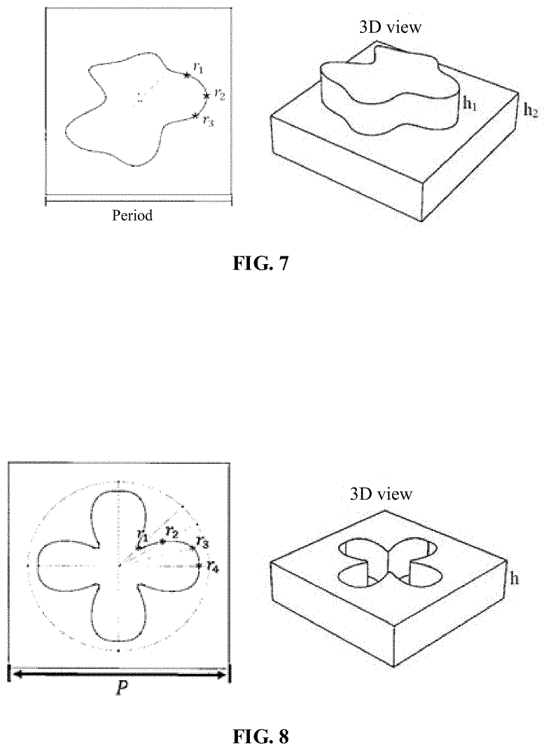

In another embodiment, optimization of micro-nano structure parameters by prediction of pass spectrum with shape of the micro-nano structure as a random graph is taken as an example for illustration. FIG. 6 is a schematic design diagram of a randomly graphic micro-nano structure according to an embodiment of the present application. As shown in FIG. 6, the parameters of the randomly graphic micro-nano structure are defined as follows: the number of points of the random structure polygon is N, the period is P, and the positions of the edge points are r₁, r₂, . . . , rₙ. Specifically, firstly, a preset pass spectrum shape is given, and an initial parameter is generated by the optimizer; then the pass spectrum corresponding to the initial parameter is predicted through the deep neural network, and the predicted pass spectrum is evaluated through the evaluation function. In the present application, the evaluation function is set as: figure of merit f=MSE (figure of merit f is equal to predicted pass spectrum minus preset target pass spectrum), and MSE represents the mean square error. The figure of merit f is input into the optimizer, and then a new parameter is generated, and this new parameter is input into the deep neural network. Through step-by-step iteration, the final parameters may be iteratively optimized to approximate the global optimal value. In addition, random polygonal cavities or random polygonal columns may be selected as the micro-nano structure. FIG. 7 is a schematic design diagram of a randomly graphic micro-nano structure with height values according to an embodiment of the present application. As shown in FIG. 7, the micro-nano structure parameters input to the deep neural network further include height values h₁ and h₂ in addition to the above parameters (the number of points of the random structure polygon N, the period P, and the positions of the edge points r₁, r₂, . . . , rₙ).

On the basis of the foregoing embodiments, the method further includes:

step 201, obtaining a plurality of initial data of different micro-nano structures, and inputting the initial data of each micro-nano structure into the trained optical parameter prediction model to obtain a plurality of optical prediction parameters, and obtaining an optical prediction measurement matrix according to the plurality of optical prediction parameters; and

step 202, evaluating the optical prediction measurement matrix based on an evaluation function and optical target parameters; when an evaluation result of the measurement matrix does not satisfy a preset condition, optimizing the initial data of each micro-nano structure through an optimization algorithm and the evaluation result of the measurement matrix to obtain the optimized data of the micro-nano structure, inputting each optimized data of the micro-nano structure into the trained optical parameter prediction model, and performing step 201 and step 202 again until the evaluation result of the optical prediction measurement matrix obtained in a current iteration satisfies the preset condition, then performing the reverse design of micro-nano structure according to a plurality of optimized data of the micro-nano structure corresponding to the optical prediction measurement matrix in the current iteration, and constructing a compressed sensor according to the plurality of micro-nano structures obtained from the reverse design.

In the present application, the optimization of the parameters of the compressed sensor composed of N micro-nano structures by prediction of pass spectrum is taken as an example for illustration. Compressed sensing is a discipline that has emerged in recent years, in which multiple micro-nano structures may be synthesized to form a compressed sensor by designing multiple micro-nano structures with varying responses. This kind of compressed sensor may be used to detect various parameters of an incident light field, and the performance of compressed sensing may be improved by optimizing the response of the micro-nano structure. Specifically, in the present application, first, the number of detectors (micro-nano structures) is set to N, if M description parameters is needed for each detector, then the input data of the deep neural network has M dimensions, and the electromagnetic response (pass spectrum) of these N micro-nano structures may be predicted by calling the deep neural network N times (or directly using parallelized computation). After predicting the pass spectrum, all pass spectrum data are formed into a measurement matrix (the pass spectrum of each micro-nano structure being regarded as a row of the matrix). The quality of the compressed sensor is equivalent to the average value of the correlation of the column vectors of the measurement matrix, and this value is used as the figure of merit. Similar to the processing process of a single optical prediction parameter in the foregoing embodiments, an optimization algorithm such as genetic algorithm may be called to automatically optimize the design. Finally, the overall design result of N structures is obtained, and these N micro-nano structures form a compressed sensor with a performance that tends to be globally optimal.

In another embodiment, for a random graph with a certain symmetry, it is partially different from the input micro-nano structure parameters in the foregoing embodiments. FIG. 8 is a schematic design diagram of a randomly graphic micro-nano structure having symmetry according to an embodiment of the present application. As shown in FIG. 8, the cavity has 90-degree rotational symmetry, and also has mirror symmetry in X and Y axis, thus the number of definition parameters of the micro-nano structure may be reduced to five, wherein one parameter is configured to define the period P of the micro-nano structure, and other four parameters are configured to define the shape of random cavities (i.e. r₁, r₂, r₃, and r₄). In the present application, the micro-nano structure of the symmetrically random graph is reversely designed, and the design steps are the same as those in the above-mentioned embodiments. The symmetrically random graph may be optimized as a whole micro-nano structure, or may be used as multiple micro-nano structures for optimization design. In addition, the operation of hollowing a cavity may be changed to shaping a column (by setting the corresponding height value).

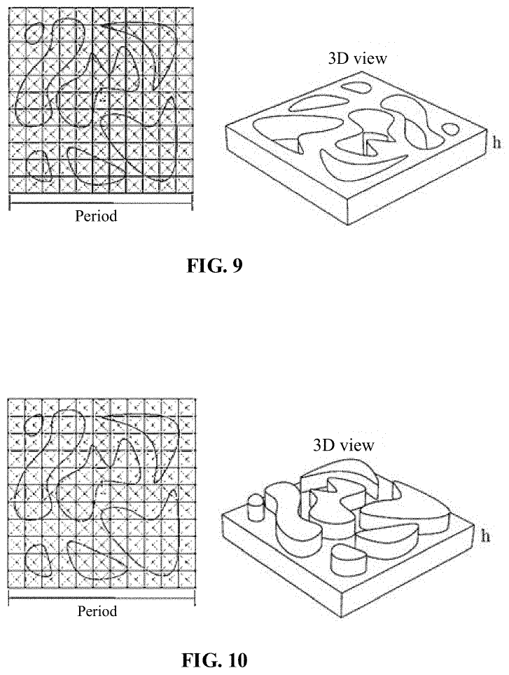

In yet another embodiment, for a micro-nano structure with multiple random graphs, the area in a single period may be divided into grids according to the period of the micro-nano structure, and then the materials at which grids are not hollowed out are randomly defined. FIG. 9 is a schematic design diagram of a micro-nano structure having multiple random graphs according to an embodiment of the present application. As shown in FIG. 9, the input micro-nano structure parameters include: 1. matrix element; all grids form a binary matrix, when the matrix element is set to 1, the material at the corresponding position will be hollowed out; when the matrix element is set to 0, no operation will be performed; 2. period P; 3. height h (i.e. thickness of plate). Using this micro-nano structure for reverse design, the multiple random graphs may be used as a whole micro-nano structure for optimization design, or may be used as multiple micro-nano structures for optimization design. In addition, the micro-nano structure may also be applied as a column. FIG. 10 is a schematic design diagram of a micro-nano structure having random graph with a height value according to an embodiment of the present application. When the micro-nano structure is a column, it may be referred to as shown in FIG. 10.

It should be noted that the materials used for the micro-nano structure in the present application include, but are not limited to, silicon, silicon nitride, silicon dioxide, GaAs, InGaAs, InGaAsP, and the like.

The core concept of the present application is to use the accelerated electromagnetic simulation of the deep neural network to convert the strict calculation of the electromagnetic response of the micro-nano structure into a prediction of the electromagnetic response of the micro-nano structure using deep neural network. Compared with strict calculation, prediction does not involve large-scale matrix solving, which may greatly speed up the calculation speed (about 10⁵ times faster). At the same time, the use of optimization algorithms may greatly improve the quality of the final optimization results, which is conducive to obtaining good results close to the global optimum. Compared with the forward design, the reverse design process of the present application is fully automated, in which only the optimization goal needs to be manually set, and then the iterative optimization will be automatically performed by a computer to obtain the design result directly, thus saving a lot of human resources. In addition, reverse design is good at designing random structures, while forward design is limited to regular structures. Therefore, the space created by the optimization parameters of reverse design is more complicated, and it is easier to obtain better design results. Moreover, the good scalability of reverse design is not only conducive to the design of the random shape of the micro-nano structure, but also suitable for the optimization of the dielectric constant, structure size and other additional parameters, and any electromagnetic response characteristics of the micro-nano structure may be reversely designed/optimized.

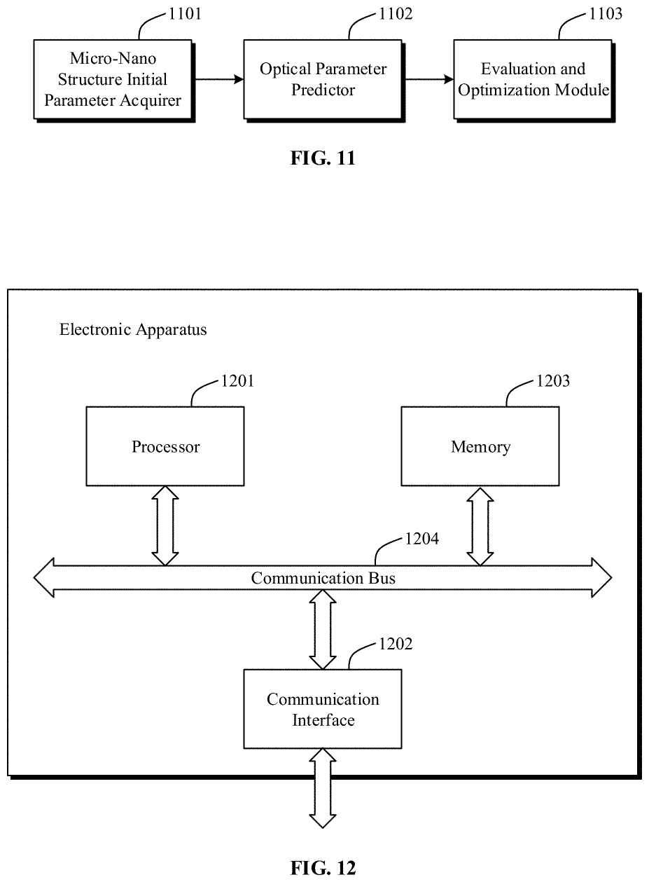

FIG. 11 is a schematic structural diagram of a system for reverse design of micro-nano structure based on deep neural network according to an embodiment of the present application. As shown in FIG. 11, the present application provides a system for reverse design of micro-nano structure based on deep neural network, including: a micro-nano structure initial parameter acquirer 1101, an optical parameter predictor 1102, and an evaluation and optimization module 1103; wherein the micro-nano structure initial parameter acquirer is configured to perform step 101 that is: acquiring initial data of a micro-nano structure according to the micro-nano structure to be reversely designed; the optical parameter predictor 1102 is configured to perform step 102 that is: inputting the initial data of the micro-nano structure into a trained optical parameter prediction model to obtain optical prediction parameters, wherein the trained optical parameter prediction model is obtained by training a deep neural network based on sample micro-nano data marked with an optical attribute parameter, and the sample micro-nano data includes sample micro-nano structure data and sample micro-nano optical characteristic data; and the evaluation and optimization module 1103 is configured to perform step 103 that is: evaluating the optical prediction parameters based on an evaluation function and an optical target parameter; when an evaluation result does not satisfy a preset condition, optimizing the initial data of the micro-nano structure through an optimization algorithm and the evaluation result to obtain optimized data of the micro-nano structure, inputting the optimized data of the micro-nano structure into the trained optical parameter prediction model, and performing step 102 and step 103 again until the evaluation result of the optical prediction parameters obtained in a current iteration satisfies the preset condition, and then performing the reverse design of micro-nano structure according to the optimized data of the micro-nano structure corresponding to the optical prediction parameters in the current iteration.

In the system for reverse design of micro-nano structure based on deep neural network provided by the present application, the deep neural network is used to predict the electromagnetic response corresponding to the structural parameters, that is, the neural network is trained to predict the electromagnetic characteristics of the micro-nano structure, and the optimal structural parameters that satisfy the target are obtained through iterative optimization according to preset optical target parameters. Since the calculation principle is based on prediction, the calculation time of the electromagnetic response is significantly shortened (10⁵ times faster) compared to the direct calculation of the electromagnetic response using simulation software, allowing for iterative optimization using optimization algorithms. Compared with the forward design, not only the parameters that tend to be globally optimal may be obtained, the design time is also greatly shortened, and significant human resources are saved.

The system provided by the present application is used to perform the above-mentioned method embodiments. For the specific process and details, please refer to the above-mentioned embodiments, which will not be repeated here.

FIG. 12 is a schematic structural diagram of an electronic apparatus according to an embodiment of the present application. As shown in FIG. 12, the electronic apparatus may include: a processor 1201, a communication interface 1202, a memory 1203, and a communication bus 1204, wherein the processor 1201, the communication interface 1202, and the memory 1203 communicate with each other through the communication bus 1204. The processor 1201 may call the logic instructions in the memory 1203 to perform the method for reverse design of micro-nano structure based on the deep neural network, which includes: step 101, acquiring initial data of a micro-nano structure according to the micro-nano structure to be reversely designed; step 102, inputting the initial data of the micro-nano structure into a trained optical parameter prediction model to obtain optical prediction parameters, wherein the trained optical parameter prediction model is obtained by training a deep neural network based on sample micro-nano data marked with an optical attribute parameter, and the sample micro-nano data includes sample micro-nano structure data and sample micro-nano optical characteristic data; and step 103, evaluating the optical prediction parameters based on an evaluation function and an optical target parameter; when an evaluation result does not satisfy a preset condition, optimizing the initial data of the micro-nano structure through an optimization algorithm and the evaluation result to obtain optimized data of the micro-nano structure, inputting the optimized data of the micro-nano structure into the trained optical parameter prediction model, and performing step 102 and step 103 again until the evaluation result of the optical prediction parameters obtained in a current iteration satisfies the preset condition, and then performing the reverse design of micro-nano structure according to the optimized data of the micro-nano structure corresponding to the optical prediction parameters in the current iteration.

In addition, the above-mentioned logical instructions in the memory 1203 may be implemented in the form of a software functional unit, and may be stored in a computer readable storage medium when sold or used as an independent product. Based on such understanding, the technical solution of the present application or a part of the technical solution may be embodied in the form of a software product, which is stored in a storage medium, including several instructions to cause a computer device, which may be a personal computer, server, or network device, etc., to perform all or part of the steps of the methods described in various embodiments of the present application. The storage medium described above includes: a U disk, a mobile hard disk, a read-only memory (ROM), a random access memory (RAM), a magnetic disk, a compact disk, and other media that can store program codes.

In another aspect, the present application further provides a computer program product, including computer programs stored on a non-transitory computer readable storage medium. The computer programs include program instructions, and when the program instructions are performed by a computer, the computer may perform the method for reverse design of micro-nano structure based on deep neural network provided by the above-mentioned embodiments, which includes: step 101, acquiring initial data of a micro-nano structure according to the micro-nano structure to be reversely designed; step 102, inputting the initial data of the micro-nano structure into a trained optical parameter prediction model to obtain optical prediction parameters, wherein the trained optical parameter prediction model is obtained by training a deep neural network based on sample micro-nano data marked with an optical attribute parameter, and the sample micro-nano data includes sample micro-nano structure data and sample micro-nano optical characteristic data; and step 103, evaluating the optical prediction parameters based on an evaluation function and an optical target parameter; when an evaluation result does not satisfy a preset condition, optimizing the initial data of the micro-nano structure through an optimization algorithm and the evaluation result to obtain optimized data of the micro-nano structure, inputting the optimized data of the micro-nano structure into the trained optical parameter prediction model, and performing step 102 and step 103 again until the evaluation result of the optical prediction parameters obtained in a current iteration satisfies the preset condition, then performing the reverse design of micro-nano structure according to the optimized data of the micro-nano structure corresponding to the optical prediction parameters in the current iteration.

In yet another aspect, the present application provides a non-transitory computer-readable storage medium, with computer programs stored thereon, and the method for reverse design of micro-nano structure based on deep neural network provided by the above-mentioned embodiments are implemented when the computer programs are performed by the processor. The method includes: step 101, acquiring initial data of a micro-nano structure according to the micro-nano structure to be reversely designed; step 102, inputting the initial data of the micro-nano structure into a trained optical parameter prediction model to obtain optical prediction parameters, wherein the trained optical parameter prediction model is obtained by training a deep neural network based on sample micro-nano data marked with an optical attribute parameter, and the sample micro-nano data includes sample micro-nano structure data and sample micro-nano optical characteristic data; and step 103, evaluating the optical prediction parameters based on an evaluation function and an optical target parameter; when an evaluation result does not satisfy a preset condition, optimizing the initial data of the micro-nano structure through an optimization algorithm and the evaluation result to obtain optimized data of the micro-nano structure, inputting the optimized data of the micro-nano structure into the trained optical parameter prediction model, and performing step 102 and step 103 again until the evaluation result of the optical prediction parameters obtained in a current iteration satisfies the preset condition, and then performing the reverse design of micro-nano structure according to the optimized data of the micro-nano structure corresponding to the optical prediction parameters in the current iteration.

The device embodiments described above are merely illustrative, wherein the units described as separate components may or may not be physically separate, and the components displayed as units may or may not be physical units, that is, may be located at the same place, or may be distributed to multiple network units. Some or all of the modules may be selected according to actual needs to achieve the purpose of the solution of the embodiments. Those of ordinary skill in the art can understand and implement the embodiments described above without paying creative labors.

Through the description of the exemplary embodiments above, those skilled in the art can clearly understand that the various embodiments can be implemented by means of software and a hardware platform, and of course, by hardware. Based on such understanding, the technical solution of the present application or a part of the technical solution may be embodied in the form of a software product, which is stored in a storage medium such as ROM/RAM, magnetic discs, compact discs, etc., including several instructions to cause a computer device (which may be a personal computer, server, or network device, etc.) to perform various embodiments or a part of the methods described in various embodiments.

Finally, it should be noted that the embodiments above-described exemplary embodiments are only for illustrating the technical solutions of the present application, and are not intended to limit the present application. Although the present application has been described in detail with reference to the foregoing embodiments, those of ordinary skill in the art should understand that they can still modify the technical solutions recorded in the foregoing embodiments, or make equivalent substitutions for some of the technical features. These modifications or substitutions do not cause the essence of the corresponding technical solutions to deviate from the scope of the technical solutions of the embodiments of the present application.

1. A method for reverse design of micro-nano structure based on a deep neural network, comprising:
step 101, acquiring initial data of a micro-nano structure according to the micro-nano structure to be reversely designed;
step 102, inputting the initial data of the micro-nano structure into a trained optical parameter prediction model to obtain optical prediction parameters, wherein the trained optical parameter prediction model is obtained by training a deep neural network based on sample micro-nano data marked with an optical attribute parameter, and the sample micro-nano data comprises sample micro-nano structure data and sample micro-nano optical characteristic data; and
step 103, evaluating the optical prediction parameters based on an evaluation function and an optical target parameter; when an evaluation result does not satisfy a preset condition, optimizing the initial data of the micro-nano structure through an optimization algorithm and the evaluation result to obtain optimized data of the micro-nano structure, inputting the optimized data of the micro-nano structure into the trained optical parameter prediction model, and performing step 102 and step 103 again until the evaluation result of the optical prediction parameters obtained in a current iteration satisfies the preset condition, then performing the reverse design of micro-nano structure according to the optimized data of the micro-nano structure corresponding to the optical prediction parameters in the current iteration.

2. The method for reverse design of micro-nano structure based on a deep neural network of claim 1, wherein the trained optical parameter prediction model is obtained by training in the following steps:
marking each sample micro-nano data with a corresponding label according to the optical attribute parameter, and constructing a training sample set according to the labeled sample micro-nano data and a corresponding sample optical parameter; and
inputting the training sample set into the deep neural network for training, and obtaining a trained optical parameter prediction model.

3. The method for reverse design of micro-nano structure based on a deep neural network of claim 1, wherein the optimization algorithm comprises a simulated annealing algorithm, a neural network algorithm and a genetic algorithm.

4. The method for reverse design of micro-nano structure based on a deep neural network of claim 1, wherein an input layer of the deep neural network is connected with a plurality of convolutional layers.

5. The method for reverse design of micro-nano structure based on a deep neural network of claim 1, further comprising:
step 201, obtaining a plurality of initial data of different micro-nano structures, and inputting the initial data of each micro-nano structure into the trained optical parameter prediction model to obtain a plurality of optical prediction parameters, and obtaining an optical prediction measurement matrix according to the plurality of optical prediction parameters; and
step 202, evaluating the optical prediction measurement matrix based on an evaluation function and optical target parameters; when an evaluation result of the measurement matrix does not satisfy a preset condition, optimizing the initial data of each micro-nano structure through an optimization algorithm and the evaluation result of the measurement matrix to obtain the optimized data of the micro-nano structure, inputting each optimized data of the micro-nano structure into the trained optical parameter prediction model, and performing step 201 and step 202 again until the evaluation result of the optical prediction measurement matrix obtained in a current iteration satisfies the preset condition, then performing the reverse design of micro-nano structure according to a plurality of optimized data of the micro-nano structure corresponding to the optical prediction measurement matrix in the current iteration, and constructing a compressed sensor according to the plurality of micro-nano structures obtained from the reverse design.

6. The method for reverse design of micro-nano structure based on a deep neural network of claim 2, wherein the sample micro-nano structure data comprises at least single-period micro-nano structure shape data and micro-nano structure period data.

7. The method for reverse design of micro-nano structure based on a deep neural network of claim 2, wherein the sample micro-nano optical characteristic data comprises at least a dielectric constant and a dispersion parameter of a micro-nano material.

8. A system for reverse design of micro-nano structure based on a deep neural network, comprising:
a micro-nano structure initial parameter acquirer configured to acquire initial data of a micro-nano structure according to the micro-nano structure to be reversely designed;
an optical parameter predictor configured to input the initial data of the micro-nano structure into a trained optical parameter prediction model to obtain optical prediction parameters, wherein the trained optical parameter prediction model is obtained by training a deep neural network based on sample micro-nano data marked with an optical attribute parameter, and the sample micro-nano data comprises sample micro-nano structure data and sample micro-nano optical characteristic data; and
an evaluation and optimization module configured to evaluate the optical prediction parameters based on an evaluation function and an optical target parameter; when an evaluation result does not satisfy a preset condition, optimize the initial data of the micro-nano structure through an optimization algorithm and the evaluation result to obtain optimized data of the micro-nano structure, input the optimized data of the micro-nano structure into the trained optical parameter prediction model, and perform step 102 and step 103 of claim 1 again until the evaluation result of the optical prediction parameters obtained in a current iteration satisfies the preset condition, then perform the reverse design of micro-nano structure according to the optimized data of the micro-nano structure corresponding to the optical prediction parameters in the current iteration.

9. An electronic apparatus, comprising a memory, a processor, and computer programs stored on the memory and executable by the processor, wherein the steps of the method for reverse design of micro-nano structure based on a deep neural network of claim 1 are implemented when the processor performs the computer programs.

10. A non-transitory computer-readable storage medium, with computer programs stored on the non-transitory computer-readable storage medium, wherein the steps of the method for reverse design of micro-nano structure based on a deep neural network of claim 1 are implemented when the computer programs are performed by a processor.

11. An electronic apparatus, comprising a memory, a processor, and computer programs stored on the memory and executable by the processor, wherein the steps of the method for reverse design of micro-nano structure based on a deep neural network of claim 2 are implemented when the processor performs the computer programs.

12. An electronic apparatus, comprising a memory, a processor, and computer programs stored on the memory and executable by the processor, wherein the steps of the method for reverse design of micro-nano structure based on a deep neural network of claim 3 are implemented when the processor performs the computer programs.

13. An electronic apparatus, comprising a memory, a processor, and computer programs stored on the memory and executable by the processor, wherein the steps of the method for reverse design of micro-nano structure based on a deep neural network of claim 4 are implemented when the processor performs the computer programs.

14. An electronic apparatus, comprising a memory, a processor, and computer programs stored on the memory and executable by the processor, wherein the steps of the method for reverse design of micro-nano structure based on a deep neural network of claim 5 are implemented when the processor performs the computer programs.

15. An electronic apparatus, comprising a memory, a processor, and computer programs stored on the memory and executable by the processor, wherein the steps of the method for reverse design of micro-nano structure based on a deep neural network of claim 6 are implemented when the processor performs the computer programs.

16. A non-transitory computer-readable storage medium, with computer programs stored on the non-transitory computer-readable storage medium, wherein the steps of the method for reverse design of micro-nano structure based on a deep neural network of claim 2 are implemented when the computer programs are performed by a processor.

17. A non-transitory computer-readable storage medium, with computer programs stored on the non-transitory computer-readable storage medium, wherein the steps of the method for reverse design of micro-nano structure based on a deep neural network of claim 3 are implemented when the computer programs are performed by a processor.

18. A non-transitory computer-readable storage medium, with computer programs stored on the non-transitory computer-readable storage medium, wherein the steps of the method for reverse design of micro-nano structure based on a deep neural network of claim 4 are implemented when the computer programs are performed by a processor.

19. A non-transitory computer-readable storage medium, with computer programs stored on the non-transitory computer-readable storage medium, wherein the steps of the method for reverse design of micro-nano structure based on a deep neural network of claim 5 are implemented when the computer programs are performed by a processor.

20. A non-transitory computer-readable storage medium, with computer programs stored on the non-transitory computer-readable storage medium, wherein the steps of the method for reverse design of micro-nano structure based on a deep neural network of claim 6 are implemented when the computer programs are performed by a processor.
